(19) United States
(12) Patent Application Publication
(10) Pub. No.: US 2020/0173613 A1
(43) Pub. Date: Jun. 4, 2020

(54) UNIVERSAL SMART LAMP

(71) Applicant: Kanghong Zhang, Santa Fe Springs, CA (US)

(72) Inventor: Kanghong Zhang, Santa Fe Springs, CA (US)

(21) Appl. No.: 16/701,406

(22) Filed: Dec. 3, 2019

Related U.S. Application Data
(60) Provisional application No. 62/774,740, filed on Dec. 3, 2018.

(51) Int. Cl. F21K 9/278; H04B 1/08; H05B 45/20; H05B 47/19; H05B 45/325; H05B 45/46

(52) U.S. Cl. CPC F21K 9/278; H04B 1/08; H05B 45/46; H05B 47/19; H05B 45/325; H05B 45/20

(57) ABSTRACT

A universal smart lamp has an LED section including an LED cover having an LED cover end. The LED end couples with a head and the head receives the LED end and is electrically connected to the LED cover end. The head has line voltage electrical contacts. The line voltage electrical contacts are electrically connected to a driver mounted within the head, or mounted within the LED section. A wireless module opening is formed on the head. A wireless module configured to be inserted into the wireless module opening. The wireless module includes a wireless receiver and electrical contacts connecting the wireless receiver to the head. The wireless module has a wireless protocol. The wireless module is removable from the wireless module opening for changing the wireless protocol to a second wireless protocol. The wireless receiver is configured to receive a wireless signal and output a PWM signal.

This application claims priority from U.S. provisional application 62/774,740 filed Dec. 3, 2018 entitled Universal Smart Lamp by Kanghong Zhang, the disclosure of which is incorporated herein by reference.

### FIELD OF THE INVENTION

The present invention is in the field of universal smart lamps.

### DISCUSSION OF RELATED ART

Traditionally, florescent lamps had tubular configurations in a variety of different diameters. The standard diameters included T12, T8 and T5 lamps for example. As users migrated to LED technology, the same dimension tubes were then made in LED format. Now, LED T8 Type AB Tubes have become popular. LED tubes in T8 format can have direct wire for connection to 120 V alternating current or operate with existing florescent lamp ballast in a plug-and-play application. The LED tubes can have greatly increased meantime before failure of greater than 50,000 hours. These LED tubes work with shunted or non shunted lamp holders and have double ended construction. Additionally, they are typically UL listed for damp locations and can be installed in enclosed luminaries.

A variety of different LED lamps have modular components. Modular cartridges can provide scented volatile components. For example, U.S. Pat. No. 7,520,635 by Jeffrey J. Wolf entitled Structures For Color Changing Light Devices filed Apr. 21, 2009 describes, “A light element includes a decorative, patterned translucent outer shell and a base. The base supports a plurality of LEDs positioned so as to emit a light show through the shell. The device also includes a compartment for receiving and securing a replaceable volatile active cartridge and a heater for enabling the device to effectively emit an active ingredient from the cartridge when the cartridge is secured in the compartment. A white light source is provided in the shell as a source of illumination along with the LEDs The device can be used as a white light source, for displaying a colored light show, for displaying colored light is schemes and for volatile active emission. The device may include an acoustic transducer for producing light and sound shows. The device may also include a light sensor, a motion detector and/or a microphone or acoustic receiver thereby enabling the light and sound show to be dependent upon ambient light intensity, motion detection and/or ambient noise.”

Also, as described in United States patent publication US 2007/0014549 A1 by inventor Scott Demarest entitled a Combination White Light and Colored LED Light Device with Active Ingredient Emission that was filed on Jan. 15, 2008 describes, “A replacement device for a light bulb includes a translucent shell and a base. The base supports a plurality of LEDs positioned so as to emit a light show through the shell. The base is configured to be received in a conventional light socket. The base also includes a compartment for receiving and securing a replaceable volatile active cartridge and a heater for enabling the device to effectively emit an active ingredient from the cartridge when the cartridge is secured in the compartment. A white light source is also provided in the shell as a source of illumination. The device can be used as a white light source, for displaying a colored light show and for volatile active emission. The volatile active may be emitted continuously when the device is used as either a white light source or for purposes of displaying a colored light show. Thus, a single device is used as a replacement for a conventional light bulb and is a combination white light source/colored light show source/volatile active source.”

Also, U.S. Pat. No. 10,323,805 by Kanghong Zhang describes a Modular LED Tube Lamp having a modular lamp base to provide different voltage configurations for modular LED tube lamps. Additionally, U.S. Pat. No. 10,480,726 also by Kanghong Zhang has a modular LED lamp system that has multiple sockets for a driver to be plugged into so that a driver can be put into the endcap, or the lamp body. Thus, lamps can have modular features that modify their aroma, light output or electrical configuration.

### SUMMARY OF THE INVENTION

A universal smart lamp has an LED section including an LED cover having an LED cover end. The LED end couples with a head and the head receives the LED end and is electrically connected to the LED cover end. The head has line voltage electrical contacts. The line voltage electrical contacts are electrically connected to a driver mounted within the head, or mounted within the LED section. A wireless module opening is formed on the head.

A wireless module configured to be inserted into the wireless module opening. The wireless module includes a wireless receiver and electrical contacts connecting the wireless receiver to the head. The wireless module has a wireless protocol. The wireless module is removable from the wireless module opening for changing the wireless protocol to a second wireless protocol. The wireless receiver is configured to receive a wireless signal and output a PWM signal.

A head socket is formed on the head for receiving the LED cover end. The module opening is formed as a side slot formed on a side of the head. The module opening is formed as a base slot formed on a side of the base. The module opening is formed as a side slot formed on a side of the head or formed as a base slot formed on a side of the base. The wireless module has an antenna contact that connects to an antenna in the head when the wireless module is inserted. The wireless module has a first contact that receives a direct current power supply.

The wireless module outputs a red control signal controlling a red LED array at a red switch, outputs a blue control signal controlling a blue LED array at a blue switch, and outputs a green control signal controlling a green LED array at a green switch. The red control signal, the blue control signal and the green control signal are PWM control signals.

Preferably, the wireless module outputs a CCT1 LED control signal that controls a CCT1 LED array at a CCT1 LED switch. The wireless module outputs a CCT2 LED control signal that controls a CCT2 LED array at a CCT2 LED switch.

Accordingly, the wireless module may have a second contact that transmits the CCT1 LED control signal, a third contact that transmits the CCT1 LED control signal, a fourth contact that transmits the red LED control signal, a fifth contact that transmits the green LED control signal, and a sixth contact that transmits the blue LED control signal. Preferably, the wireless module has first ground contact for the control signal wire harness, and a second ground contact for the wireless module housing frame.

### BRIEF DESCRIPTION OF THE DRAWINGS

FIG. 1 is an assembly diagram of the present invention.

FIG. 2 is a close-up view of the wireless module.

FIG. 3 is an electrical diagram showing a completed RGBWW circuit when the wireless module is inserted into the head 30.

FIG. 4 is an electrical diagram showing a completed WW circuit when the wireless module is inserted into the head 30.

FIG. 5 and electrical diagram showing a RGB completed circuit when the wireless module is inserted into the head 30.

The following call out list of elements can be a useful guide in referencing the element numbers of the drawings.
20 LED Section
21 LED Cover
22 Cover End
23 Cover Opening
24 LED Chip
25 LED Board
26 LED Board Contact
29 Transceiver
30 Head
31 First Prong
32 Second Prong
33 Side Slot
34 Base Slot
35 Driver
36 Side Wireless Module
37 Base Wireless Module
38 Wireless Module Housing
39 Head Socket
40 Wireless Module
41 First Contact
42 Second Contact
43 Third Contact
44 Fourth Contact
45 Fifth Contact
46 Sixth Contact
47 Antenna Contact
48 Ground Contact
49 Groove Grip
51 Module Frame Ground Contact
52 Antenna
53 CCT1 Switch
54 CCT2 Switch
55 Red Switch
56 Green Switch
57 Blue Switch
58 Common Ground
59 Frame Ground
60 LED Array
61 CCT1 LED Array
62 CCT2 LED Array
63 Red LED Array
64 Green LED Array
65 Blue LED Array
66 Wireless Signal
67 PWM Signal
68 Transmitter
69 Control Signal Wire Harness

### DETAILED DESCRIPTION OF THE PREFERRED EMBODIMENT

### Glossary

### RGB Red Green Blue

### WW White and White

### RGBWW Red Green Blue White and White

ANSI stands for the American National Standard Institute
AC stands for alternating current
LED stands for a light emitting diode
MOSFET stands for a metal oxide semiconductor field effect transistor
PWM stands for pulse width modulation
IGBT stands for a insulated gate bipolar transistor
BJT stands for a bipolar junction transistor
Thyristor is a four-layer device with alternating P-type and N-type semiconductors
GTO stands for gate turn off thyristor
JFET stands for junction gate field effect transistor
ANSI C136.48 is a standard by the American National Standard Institute for roadway and area lighting equipment wireless network lighting controllers by (NEMA) National Electrical Manufacturers Association
Type AB is a type of light tube
UL stands for Underwriter Laboratories a testing and certification service

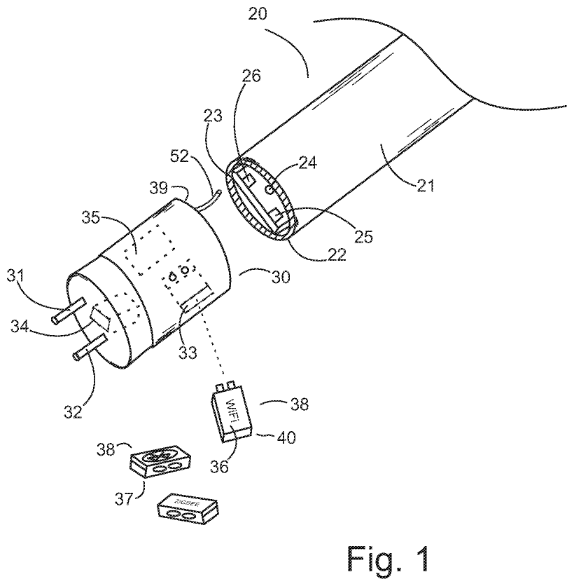

As seen in FIG. 1, the lamp generally includes an LED section 20 with an LED cover 21. The LED cover can be formed as a transparent or translucent plastic tube with a pair of open ends. The cover end 22 shows a cover opening 23 which is circular when formed as a circular tube. The cover opening 23 receives an LED board 25. LED chips 24 can be mounted to the LED board 25 in a variety of different arrays such as columns and rows. The LED board 25 also preferably has LED board contacts 26.

The LED section 20 is mounted to a head 30. A pair of heads can include a first head for a first end, and a second head for a second end. The heads are formed as end caps preferably having a slightly larger diameter than the LED cover 21 so that a head socket 39 of the head 30 can receive the LED cover 21. The head socket 39 has an inside surface that can snap fit to the LED cover 21 such as by a threaded connection, adhesive, or by interference fit. Optionally, the head socket 39 can be sonically welded to the LED cover 21. The head 30 also has line voltage electrical contacts which are preferably formed as a first prong 31 and a second prong 32 protruding away from the head 30. The first prong 31 and the second prong 32 are electrically connected to a driver 35 for powering the driver 35. The driver 35 is in turn electrically connected to the LED board 25 at the LED board contacts 26.

The head 30 preferably includes a module opening formed as either a side slot 33, or a base slot 34, or both a side slot 33 and a base slot 34. The side slot 33 preferably receives a side wireless module 36, and the base slot 34 preferably receives a base wireless module 37. The base wireless module 37 and the side wireless module 36 can have a wireless module housing 38 formed as a cartridge for inserting the wireless transceiver within the wireless module into the wireless module slots. The side slot 33 is configured for receiving the side wireless module 36, and the base slot 34 is configured for receiving the base wireless module 37.

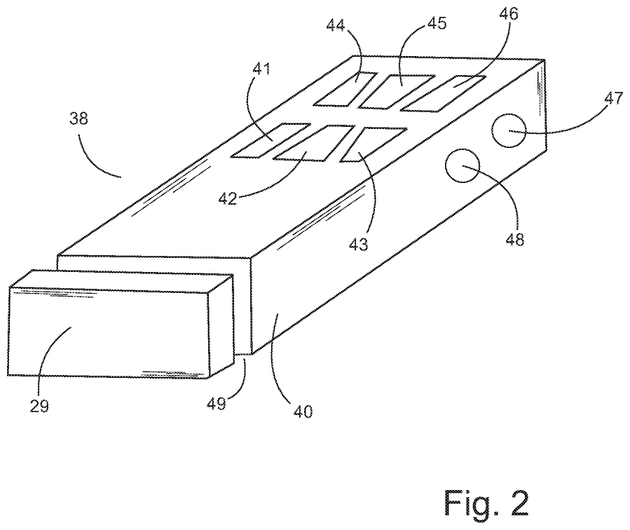

As seen in FIG. 2, the wireless modules 40 are preferably rectangular and have a flat upper surface and a flat lower surface greater than a side surface. The wireless module 40 can be a transceiver or receiver. A variety of different contacts can be mounted on the flat upper or lower surface such as a first contact 41, a second contact 42, a third contact 43, a fourth contact 44, a fifth contact 45, and a sixth contact 46. The antenna contact 47 and a ground contact 48 can be formed on a side of the wireless module 40. The wireless module optionally does not have its own antenna 52. Instead, it can connect to electrical contacts for making electrical connection to an antenna formed on the head 30. The antenna 52 can be formed as a wire mounted to an inside surface of the head 30, or fitting into the cover opening 23. The contacts on the wireless module 40 can be spring-loaded posts, or can be rigid and flat. The contacts on the wireless module 40 engage contacts on the head. Contacts on the head can also be flat or spring-loaded protruding posts.

A transceiver 29 is mounted in the wireless module 40. The wireless module 40 may have a groove grip 49 formed as a groove or channel to allow removal of the wireless module using a coin or tool. The wireless module preferably has a set of contacts disposed on a flat face of wireless module. The wireless module can be formed as a PCB board, or a PCB board housed within a housing.

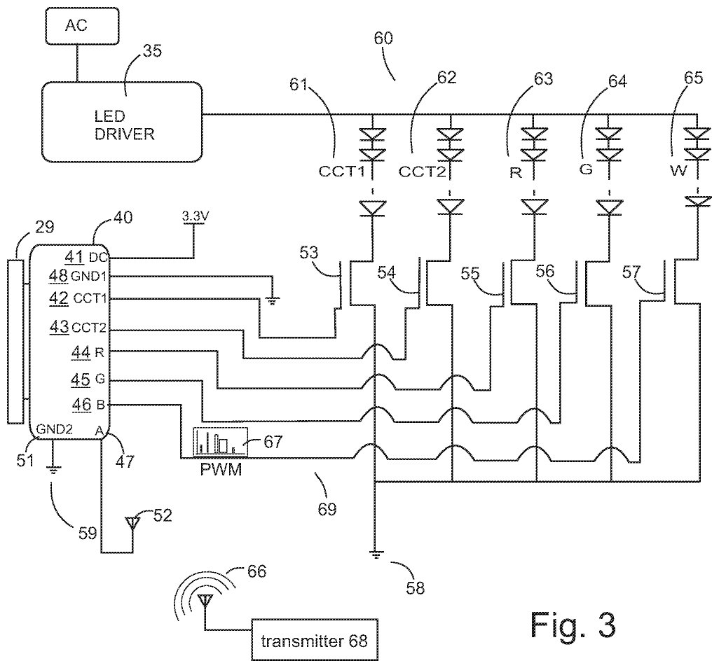

As seen in FIG. 3, the wireless module 40 a provides a control signal such as a PWM signal to a variety of different control signal switches which can be independent of each other such as on different channels. The control switches are preferably single power electronic switches such as a MOSFET, IGBT, BJT, Thyristor, GTO or JFET. The control switches receive control signals from the wireless module. Different arrays of LED chips can be controlled with the control signal. Generally, the transmitter 68 transmits wireless signal 66 which is received by the wireless module 40 having a transceiver or receiver 29. The wireless module 40 then generates a PWM signal 67 such as on the blue or white LED array 65 for making blue or white light. The PWM signals including the red PWM signal, the green PWM signal, and the blue PWM signal are transmitted on a wire harness 69 which have a ground.

The driver 35 is connected to the pair of prongs or other electrical contacts that supply AC power to the universal smart lamp. The driver 35 is preferably connected to an LED array 60 which may include a CCT1 LED array 61, a CCT2 LED array 62, a red LED array 63, a green LED array 64, and a blue LED array 65. The CCT1 LED array 61 can be a first color correlated temperature array having a first color, and a CCT2 LED array 62, can be a second color correlated temperature array having a second color. In this way, the lamp can change color by activating different LED arrays. The driver 35 also powers different arrays of different colors such as the red LED array 63 which when combined with the green LED array 64 can make a yellow light output for example. The blue LED array 65 can have blue LEDs, white LEDs or blue and white LEDs for example.

The driver output to these LED arrays is controlled at the set of control switches. The control switches include a CCT1 switch 53, a CCT2 switch 54, a red switch 55, a green switch 56, and a blue switch 57. The driver 35 is also preferably mounted in the head 30, but could also be mounted on the LED board 25. The LED array 60 is mounted on the LED board 25.

When inserted, the wireless transceiver module makes electrical contacts. In the present example, the first contact 41 can receive a 3.3 V direct current power supply. The second contact 42 can be a CCT1 LED array contact which electrically connects to the CCT1 switch 53 which in turn controls the CCT1 LED array 61. The third contact 43 can be a CCT2 LED array contact which electrically connects to the CCT2 LED array 62 which in turn controls the CCT2 LED array 62. The fourth contact 44 can be a red LED array contact which electrically connects to the red switch 55, which in turn controls the red LED array 63. The fifth contact 45 can be a green LED array contact which electrically connects to the green switch 56, which in turn controls the green LED array 64. The sixth contact 46 can be a blue LED array contact which electrically connects to the blue switch 57, which in turn controls the blue LED array 65.

The antenna contact 47 makes connection to the antenna 52. A ground contact 48 formed on a flat external surface of the wireless transceiver module, such as on the top surface of the wireless transceiver module can make a ground connection to ground. A second ground can be implemented as a module frame ground contact 51 which can be formed as a metal portion of the wireless transceiver module housing. The module frame ground contact 51 connects to a frame ground 59. Similarly, a common ground 58 connects to all of the LED arrays.

When the wireless transceiver 29 receives a signal, the wireless signal is preferably converted to a PWM signal which activates the appropriate switch. The wireless signal can be Wi-Fi, Zig-Bee, Bluetooth, IEEE 802.15.4 or ANSI C136.48 signal. The wireless module 40 has a wireless transceiver or receiver 29 that converts the wireless signal to a PWM signal. The PWM signal then controls the set of control switches. Each wireless module having a single protocol would handle a particular type of signal, and thus a first wireless module can be a Wi-Fi wireless module, a second wireless module can be a Zig-Bee wireless module, a third wireless module can be a Bluetooth wireless module, a fourth wireless module can be an IEEE 802.15.4 wireless module and a fifth wireless module can be an ANSI C136.48 wireless module.

Each wireless module 40 is configured to receive one wireless standard so that the wireless module 40 comes in a variety of different wireless standards. When a user changes from one wireless standard to another, the user could remove the old wireless module 40 from the side slot 33 or base slot 34. The user could then insert a new wireless module 40. In this way, a user can define different groups of lights and different lights can be controlled using different protocols and standards. For example, the user could have the lights near a Wi-Fi router controlled by Wi-Fi, and then the user could control the lights in a different room using Zig-Bee, and then control the light next to her desk using Bluetooth. Providing a modular solution with different flavors of wireless modules 40, each with a single protocol, provides the user with a variety of different configuration options by switching around different wireless modules 40. If the user is operating a factory, the user could keep a single batch of inventory with uninstalled wireless modules, and then ship the goods with wireless modules for the end-user to insert into the appropriate slots. If the shipping department accidentally sent the wrong wireless modules, the customer service department could easily send the correct wireless modules to the end-user customer without involving the main physical portion of the lamps.

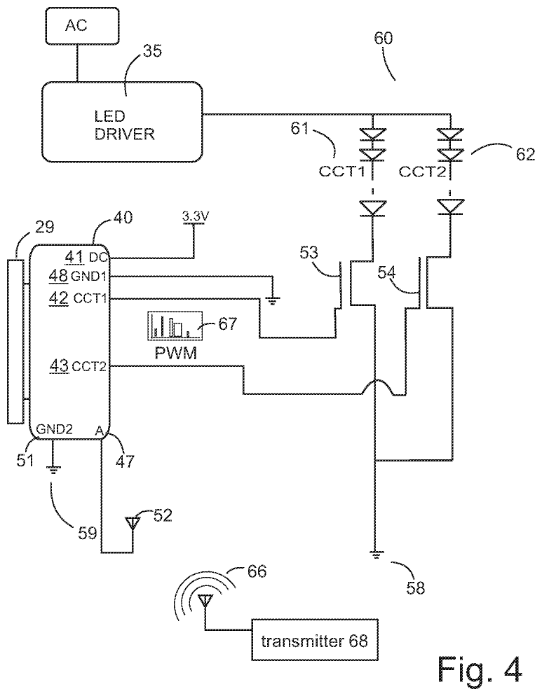

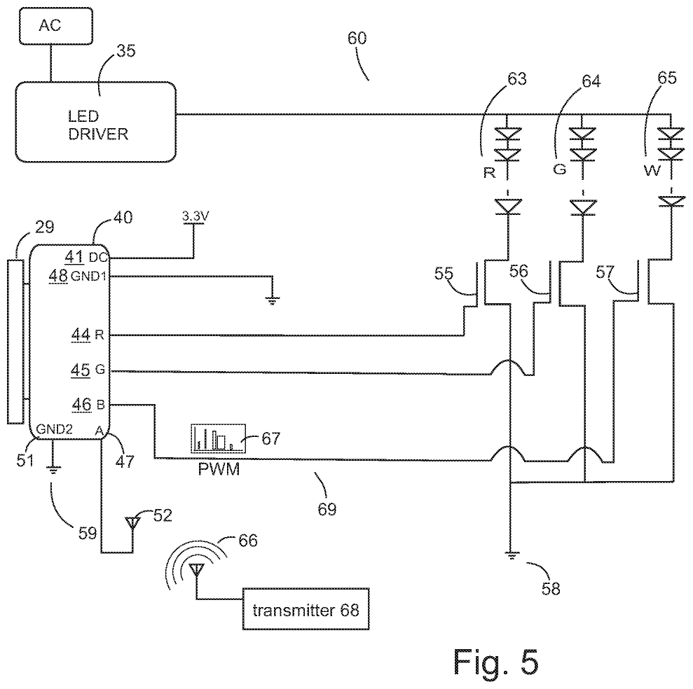

As seen in FIGS. 4-5 the configuration can be just a WW or RGB configuration instead of the full RGBWW configuration of the third figure. The LED section 20 of the WW or RGB configuration are preferable structurally interchangable with each other. WW stands for white and white. Light commonly referred to as white comes in different shades which is quantified by color temperature.

Optionally, the wireless modules can be color-coded for easy identification, and preferably have diverse external tactile surface identification for ease of user identification and handling in the dark. Surface identification may include raised dots or the like.

1. A universal smart lamp comprising:
an LED section including an LED cover having an LED cover end, wherein the LED end couples with a head, wherein the head receives the LED end and is electrically connected to the LED cover end, wherein the head has line voltage electrical contacts, wherein the line voltage electrical contacts are electrically connected to a driver mounted within the head, or mounted within the LED section;
a wireless module opening formed on the head; and
a wireless module configured to be inserted into the wireless module opening, wherein the wireless module includes a wireless receiver and electrical contacts connecting the wireless receiver to the head, wherein the wireless module has a wireless protocol, wherein the wireless module is removable from the wireless module opening for changing the wireless protocol to a second wireless protocol, wherein the wireless receiver is configured to receive a wireless signal and output a PWM signal.

2. The universal smart lamp of claim 1, further including a head socket formed on the head for receiving the LED cover end.

3. The universal smart lamp of claim 2, wherein the module opening is formed as a side slot formed on a side of the head.

4. The universal smart lamp of claim 2, wherein the module opening is formed as a base slot formed on a side of the base.

5. The universal smart lamp of claim 2, wherein the module opening is formed as a side slot formed on a side of the head or formed as a base slot formed on a side of the base.

6. The universal smart lamp of claim 5, wherein the wireless module has an antenna contact that connects to an antenna in the head when the wireless module is inserted.

7. The universal smart lamp of claim 5, wherein the wireless module has a first contact that receives a direct current power supply.

8. The universal smart lamp of claim 7, wherein the wireless module outputs a red control signal controlling a red LED array at a red switch, wherein the wireless module outputs a blue control signal controlling a blue LED array at a blue switch, wherein the wireless module outputs a green control signal controlling a green LED array at a green switch, wherein the red control signal, the blue control signal and the green control signal are PWM control signals.

9. The universal smart lamp of claim 7, wherein the wireless module outputs a CCT1 LED control signal that controls a CCT1 LED array at a CCT1 LED switch, and wherein the wireless module outputs a CCT2 LED control signal that controls a CCT2 LED array at a CCT2 LED switch.

10. The universal smart lamp of claim 9, wherein the wireless module outputs a red control signal controlling a red LED array at a red switch, wherein the wireless module outputs a blue control signal controlling a blue LED array at a blue switch, wherein the wireless module outputs a green control signal controlling a green LED array at a green switch, wherein the red control signal, the blue control signal and the green control signal are PWM control signals.

11. The universal smart lamp of claim 9, wherein the wireless module has a second contact that transmits the CCT1 LED control signal, wherein the wireless module has a third contact that transmits the CCT1 LED control signal, wherein the wireless module has a fourth contact that transmits the red LED control signal, wherein the wireless module has a fifth contact that transmits the green LED control signal, wherein the wireless module has a sixth contact that transmits the blue LED control signal.

12. The universal smart lamp of claim 9, wherein the wireless module has first ground contact for the control signal wire harness, and a second ground contact for the wireless module housing frame.
